(19) United States
(12) Patent Application Publication
(10) Pub. No.: US 2025/0238342 A1
(43) Pub. Date: Jul. 24, 2025

(54) DETERMINATION OF USER OPERATIONS AT A DATA PROCESSING SYSTEM

(71) Applicant: Fortinet, Inc., Sunnyvale, CA (US)

(72) Inventor: Simon James Winn Evans, Ashampstead (GB)

(73) Assignee: Fortinet, Inc., Sunnyvale, CA (US)

(21) Appl. No.: 19/028,797

(22) Filed: Jan. 17, 2025

(30) Foreign Application Priority Data
Jan. 19, 2024 (GB) 2400767.6

(51) Int. Cl. G06F 11/34; G06F 21/50

(52) U.S. Cl. CPC G06F 11/3438; G06F 21/50

(57) ABSTRACT

Methods are described for determining user operations at a data processing system. In one example, an agent is established at the data processing system that has access to data indicating, for each of multiple user space applications, an association between (i) a set of multiple calls by the user space application to one or more software functions and (ii) a specific operation of the user space application. A set of calls by a given user space application to one or more software functions is received by the agent. It is determined that the set of calls are characteristic of a specific operation of the given user space application by processing the set of calls based on the data. One or both of generating a report regarding the specific operation and influencing functioning of the given user space application are then performed.

### CROSS REFERENCE TO RELATED APPLICATIONS

This patent application is related to and, under 35 U.S.C. 119, claims the benefit of and priority to Great Britain Patent Application No. 2400767.6, entitled DETERMINATION OF USER OPERATIONS AT A DATA PROCESSING SYSTEM, by Simon James Winn Evans, filed Jan. 19, 2024, which is hereby incorporated by reference in its entirety for all purposes.

### BACKGROUND

### Field

Various embodiments of the present disclosure generally relate to endpoint security. In particular, some embodiments relate to the monitoring of data processing systems to determine user operations.

### Description of the Related Art

Organizations implementing networks of computing devices may have cyber security solutions in place, including firewalls, network security appliances and antivirus solutions. However, such measures cannot necessarily manage insider risks. Intentional, or unintentional but damaging, actions by users of computing devices in a network can be a serious vulnerability to organizations that traditional tools may not be able to defend against.

Common identity management (CIM) tools cannot necessarily prevent a malicious insider with credentials from performing damaging actions, as they lack certain context. For example, sensitive data can be hosted on servers with access control rules, but they cannot quantify how it is affected by users' poor cyber hygiene practices. They also cannot track the effectiveness of their security controls and training.

Rules defined in security policies that are implemented by entities in a network can be an efficient way to detect real-world insider risk scenarios. For example, policies may be defined so as to permit the detection of users who use restricted administrative tools, send sensitive information outside of the organization, circumvent security restrictions or suspiciously print documents during unusual hours. The violation of such policies can be used to raise a security event at a data processing system, which can be reported to an administrator for further monitoring or result in certain user operations being blocked, which may improve the security of endpoints in a network.

To determine whether rules such as security policies have been violated, it is desirable to monitor user activity at a data processing system such as a computer.

One way for security products to monitor processes occurring at a data processing system as a result of user activity is to apply “hooks” on the user space applications that the process may use. This may allow function calls to be intercepted in user space. If a process calls a hooked function that is defined in a security policy, such as WriteFile( ), then a security event can be raised by a security product or the result of the hooked function can be changed to prevent the operation from completing.

This is an acceptable approach if such hooks are the only ones being performed, however this can become complex if multiple agents are involved. Furthermore, in addition to user space hooks, a kernel mode hook may also be required, further increasing complexity.

Another approach that can be used is to simply walk the call stack to analyze call sites and disassemble the code to look for a call (or similar) instruction to the target application programming interface (API). This approach is generally more efficient than using a user space hook, but in the general case the code for those call sites will not be in the data cache or even in the data translation lookaside buffer.

These known approaches are generally computationally expensive and can involve accessing the memory of the data processing system multiple times.

It is desirable to develop an approach for determining the actions of users at a data processing system that is more computationally efficient than existing methods.

### SUMMARY

According to one aspect, a data processing system is configured to implement one or more user space applications and an operating system kernel governing access by the user space applications to software functions that can be implemented by the data processing system. A non-transitory machine readable medium storing instructions, which when executed by one or more processors of the data processing system causes the one or more processors to establish a software entity at the data processing system configured to act as a local monitoring entity for the data processing system, the entity having access to data indicating an association between (i) a set of multiple calls by a user space application to one or more of the software functions and (ii) a specific operation of a user space application; receive, at the local monitoring entity, a set of calls by a user space application to one or more of the software functions; process the set of calls in dependence on the data to determine whether the set of calls are characteristic of a specific operation of a user space application; and in response to the set of calls being characteristic of a specific operation of a user space application, generate a report of that operation and/or influence the functioning of the user space application.

At least one of the set of calls may be determined by, using the local monitoring entity, signaling the kernel to determine one or more calls by a user space application to one or more of the software functions.

The instructions may further cause the one or more processors to signal the kernel to determine the set of calls by a user space application using a kernel mode hook.

At least one of the set of calls may be determined using an event tracing application.

The instructions may further cause the one or more processors to receive an event trace log file from the event tracing application and determine the set of calls from the event trace log file.

The specific operation of the user space application may be an application programming interface call of the user space application.

The processing of the determined set of calls in dependence on the predetermined data may comprise processing memory addresses specified by the set of calls.

The instructions may further the one or more processors to learn one or more specific operations and respective associated sets of multiple calls based on user activity at the data processing system.

The data indicating an association between (i) a set of multiple calls by a user space application to one or more of the software functions and (ii) a specific operation of a user space application is predetermined data.

The data may comprise a trained machine learning model. The model may be implemented by the one or more processors to process the set of calls to determine whether the set of calls are characteristic of a specific operation of a user space application.

The trained machine learning model may be trained based on activity at one or more other data processing devices.

The data indicating an association between (i) a set of multiple calls by a user space application to one or more of the software functions and (ii) a specific operation of a user space application may comprise one or more trained classifiers.

The instructions may cause further the one or more processors to detect one or more patterns in the set of calls and compare the pattern(s) to patterns specified in the data.

The data may comprise a library of patterns of calls, each pattern having a corresponding associated specific operation of a user space application.

The patterns may be learned at one or more other data processing systems. The patterns learned at other data processing systems may be shared with the data processing system and used to detect specific operations of user space applications at the data processing system. New patterns detected at the data processing system may be shared with other data processing systems, which may use the patterns to detect specific operations of user space application at their respective systems.

The specific operations and their associated patterns of calls may be determined using application programming interface probes. Probes may be used to record execution traces at the data processing system or another data processing system for a short period of time. The recorded traces may be used as patterns as described above. The patterns may be detected in received sets of calls and used to determine specific operations of a user space application without requiring the use of such probes at all times. This may be more computationally efficient.

If the received set of calls differs from one of the patterns specified in the data by less than a threshold number of calls, the instructions may further cause the one or more processors to determine the received set of calls as being characteristic of the specific operation of a user space application corresponding to that one pattern of the patterns and generate a report of that operation and/or influence the functioning of the user space application.

The instructions may further the one or more processors to store the received set of calls as a new pattern in the data indicating an association between (i) the received set of calls and (ii) the specific operation of a user space application corresponding to that one pattern.

The new pattern may correspond to a version of a user space application unknown to the software entity. The data may not initially comprise patterns of calls corresponding to specific operations of that version of the user space application. This may allow the detection of specific operations of new versions of a user space application, for example a version of an application with an unknown binary. Newly detected patterns can be subsequently added to the data to allow patterns of calls for that version of the user space application to be matched to received sets of calls. This may allow operations by newer versions of user space applications to be subsequently detected.

A first pattern may be stored in the data as a baseline. The first pattern may correspond to a first specific operation of a user space application. If a subsequently detected set of calls differs from the first pattern by less than a predetermined number of calls, the instructions may cause the one or more processors to determine the received set of calls as being characteristic of the first specific operation of a user space application corresponding to the first pattern and generate a report of that operation and/or influence the functioning of the user space application.

The determined set of calls may comprise calls from multiple operations of a user space application. The determined set of calls may comprise calls from operations of more than one user space application of a plurality of user space applications implemented by the data processing system. The instructions may further cause the one or more processors to determine which calls of the set of calls are characteristic of the specific operation of the user space application. The instructions may cause the one or more processors to determine which calls of the set of calls are characteristic of a specific operation of one of the user space applications.

The instructions may further cause the one or more processors to influence the functioning of the user space application by modifying future calls by the user space application to one or more software functions.

In response to the determined set of calls being characteristic of a specific operation of a user space application, the instructions may cause the user space application to be terminated.

In response to the determined set of calls being characteristic of a specific operation of a user space application, the instructions may cause the local monitoring entity to raise a security event.

The instructions may cause the raised security event to be reported to a remote monitoring entity.

The specific operation may comprise one or more of opening a file, copying a file sharing a file, exfiltrating a file and opening a network connection.

The data may indicate an association between (i) a set of multiple calls by one of the one or more user space applications to one or more of the software functions and (ii) a specific operation of the one of the user space applications. The one or more processors may receive, at the local monitoring entity, a set of calls by one or more of the user space applications to one or more of the software functions; process the set of calls in dependence on the data to determine whether the set of calls are characteristic of a specific operation of one of the user space applications; and in response to the set of calls being characteristic of a specific operation of one of the user space applications, generate a report of that operation and/or influence the functioning of the one of the user space applications.

The software entity configured to act as a local monitoring entity may be an endpoint security software entity.

Other features of embodiments of the present disclosure will be apparent from accompanying drawings and detailed description that follows.

### BRIEF DESCRIPTION OF THE FIGURES

Various embodiments will now be described by way of example with reference to the accompanying drawings.

In the drawings:

FIG. 1 schematically illustrates a network of computing devices.

FIG. 2 schematically illustrates the monitoring of an operating system kernel of a data processing system and the user of an event tracing application to determine sets of calls made to software functions that can be implemented by the data processing system.

FIG. 3 shows an example of a method for implementation at a data processing system.

### DETAILED DESCRIPTION

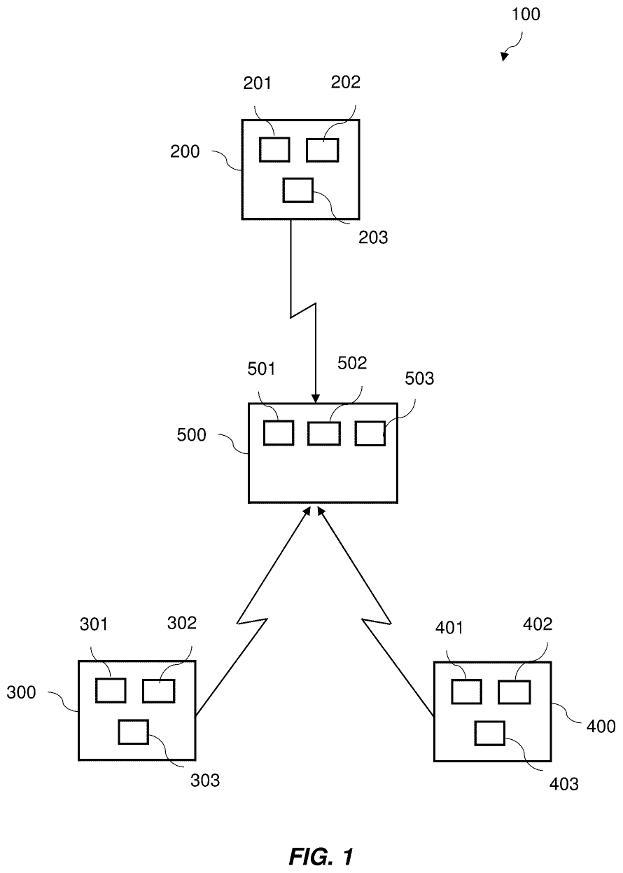

FIG. 1 schematically illustrates a network 100 comprising multiple data processing systems. In this example, the data processing systems are computing devices 200, 300, 400. Each computing device may be, for example, a desktop computer, laptop computer, tablet, mobile phone and/or server computer or a combination thereof. Other suitable computing devices may also be implemented in such a network. The devices may be connected in the network by wired and/or wireless connections. The network may, for example, be a corporate network. Access to the network may be restricted, for example by security devices that filter traffic at the boundary of the network. The network may interface via such security devices to a publicly accessible network such as the internet.

Computing devices 200, 300, 400 each comprise a processor 201, 301, 401 and a memory 202, 302, 402. The processor 201, 301, 401 may be implemented as dedicated hardware. Alternatively, the processor 201, 301 401 may be implemented as a computer program running on a programmable device such as a central processing unit (CPU). The respective memory 202, 302, 402 is arranged to communicate with the respective processor 201, 301, 401. Memory 202, 302, 402 may be a non-volatile memory. Each device 200, 300, 400 may comprise more than one processor and more than one memory. The memory may store data (i.e. the memory is a data carrier) that is executable by the processor. By executing program code contained in such data, the one or more processors may perform functions as described herein. The memory may store such program code in a non-transitory manner. The processor may be configured to operate in accordance with a computer program stored in non-transitory form on a machine readable storage medium. The computer program may store instructions for causing the processor to perform its methods in the manner described herein.

Each computing device 200, 300, 400 can support a local software entity or agent. The software entity is able to collect information relating to the computing device and/or a user thereof. There may be one or more users authenticated to the computing device 200. The computing device supports the agent by storing and executing program code which, when executed, implements the agent. In this example the agent is a software entity. The agent may be implemented by one or more principal processors of the computing device, which processor(s) also implement functions of the computing device that implement the computing device's core functions. For example, if the computing device is a desktop computer, its core functions may include sending and receiving email and performing word processing tasks. Thus the principal processors may divide their time between implementing the agent and implementing other functions. Alternatively a dedicated processor may implement the agent.

The agent may be implemented as a user space application program. As used herein, user space applications are applications running in the user space, which is the memory area and a hardware privilege level of a data processing system where, for example, application software and some drivers may execute. The user space may be a limited part of the total memory of the data processing system (e.g. computing device). A user space application may have a corresponding user interface (UI) whereby a user can interact with the application. For example, the user may provide input to the application via the UI. In contrast to user space, kernel space (or supervisor mode) is memory area and hardware privilege level of the data processing system reserved for running an operating system kernel.

In addition to implementing the agent, the computing device may also implement other user space applications. The computing device may implement one or more user space applications that are not the agent.

Each device 200, 300, 400 may also comprise a transceiver 203, 303, 403 which allows the respective device to communicate with a remote monitoring entity at the central infrastructure apparatus 500.

Central infrastructure apparatus 500 also comprises a processor 501, a memory 502 and a transceiver 503. Processor 501 and memory 502 may operate as described above with reference to processor 201 and memory 202. The apparatus 500 may comprise more than one processor and more than one memory. Transceiver 503 may send or receive data to or from the transceivers 203, 303, 403 of any of the computing devices 200, 300, 400 in the network. The apparatus 500 may be communicatively coupled to a user interface which can, for example, allow a user of the apparatus 500 to specify particular settings relating to the security of files.

Each computing device 200, 300, 400 may receive information, such as security policies, from the apparatus 500. Each computing device 200, 300, 400 may also receive updates to the software entity that implements the agent from the central infrastructure apparatus 500. Each computing device 200, 300, 400 may also send information to the apparatus 500.

The computing devices 200, 300, 400 may implement different operating systems. For example, each computing device may implement one of the macOS, Windows or Linux operating systems.

Taking computing device 300 as example, computing device 300 implements a software entity in the form of an agent which monitors the computing device. The computing device 300 may implement a version of the agent suitable for the operating system running on the device 300.

The agent, which acts as the local monitoring entity, monitors the computing device. The agent may monitor the operating system kernel on the device, and/or monitor applications running on the device, such as web browsers, email clients and event tracing applications (as will be described in more detail later).

The processor of the computing device 300 has access to multiple criteria. The criteria may be stored at a memory of the device. The criteria may be received from another device, such as the central infrastructure apparatus 500. Updates to these criteria may be made as appropriate. The criteria may specify one or more actions. If the one or more actions are detected by the agent to have occurred at the device, the agent can raise an event. The criteria may be stored at the device. The criteria may be predefined criteria. For example, an event may be raised when a user performs an action for the first time, and/or performs an action outside of normal working hours. In some examples, the criteria may define an event. In other implementations, the criteria may be defined by parameters of a model, such as a machine learning or statistical model. The agent may raise an event when the output of the model, based on input to the model associated with activity at the device 300, indicates that an event should be raised. The model may be received from the central infrastructure apparatus 500. The model may be stored at the memory 302 of the device 300 and be accessible by the processor 301. The processor 301 may execute the model.

The one or more criteria may be defined in one or more security policies. The policies may be received by the agent implemented at the computing device from the central infrastructure apparatus. The local monitoring agent is configured to determine whether to raise an event in dependence on the one or more security policies. Security policies are configurable rules that can be used to raise sensors/alerts based on activity detected by the local monitoring entity (agent). The security policies preferably comprise a specification of actions on a computing device supporting a local monitoring entity that that local monitoring entity should report to a remote monitoring entity. Policies may specify actions such as the use of restricted administrative tools, sending sensitive information outside of the organization, circumventing security, accessing files, downloading data onto a USB device, and printing documents during irregular hours. Events may therefore be detected based on security policies comprising a specification of actions on the data processing system that the local monitoring entity is to report to a remote monitoring entity. Policies may also specify one or more particular attributes of a file, for example, file content or a part thereof, properties or characteristics of the file (such as file type, file name etc.), or metadata associated with the file.

If one or more of the actions defined in one or more of the criteria (for example, defined in one or more security policies) are detected as having occurred, the local monitoring entity can raise an event. Raised events can be reported to a remote monitoring entity. The remote monitoring entity may be implemented at the central infrastructure 500. The raising of the event indicates that the violation of a security policy has occurred. In response, the remote monitoring entity may raise an alert and/or log the violation, optionally along with the user identifier of the user that violated the policy. In response to an event being raised, the device 200 or the infrastructure 500 may generate a visible and/or audible alert, and/or may store data relating to the policy violation. This stored data can be accessed by a user, such as an administrator.

As mentioned above, once events have been raised, they can be analyzed at the device 300 and/or reported to the remote monitoring entity 500. This is generally performed by sending the events from the local device to the remote monitoring entity via a network, such as the internet. If there is no connection between the device 300 and the infrastructure 500 at the time that the event is raised, the event can be stored at the device until a connection between the local monitoring entity and the remote monitoring entity is established or resumed. The events may be stored at the device 300 in a buffer. The buffer may be part of memory 302. The buffer may be in the form of a spooler. Events may be stored in the buffer in a queue.

When raising events, it is desirable to determine that specific user actions corresponding to particular events have been performed at the computing device without a user space hook, which can be computationally expensive. For example, in order for an event to be raised, the agent may need to determine that the user has, for example, requested to print a document out of hours, or has requested to write a file to a USB stick. The following describes exemplary ways in which this can be achieved.

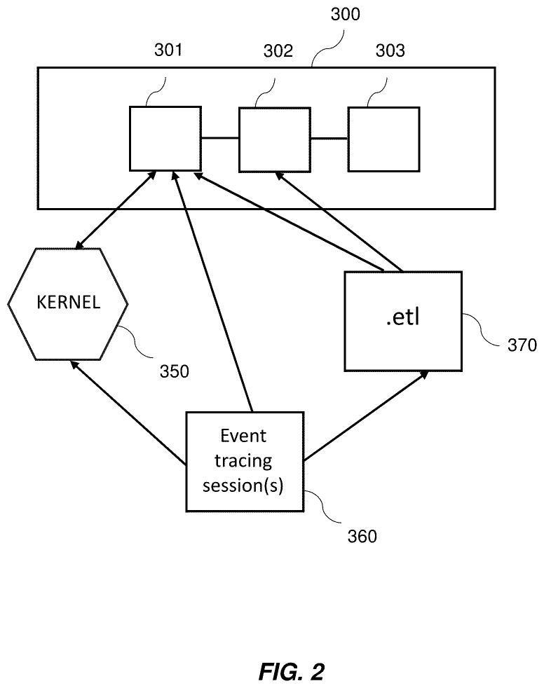

FIG. 2 shows exemplary operations performed by computing device 300. As described above, processor 301 can implement the agent as a software entity. In addition to implementing the agent, the computing device may also implement other user space applications. The computing device may implement a set of user space applications that are not the agent. Thus, the set of user space applications does not comprise the software entity implementing the agent. The set may comprise one or more applications.

The processor 301 also implements the operating system kernel, shown schematically at 350. The operating system kernel 350 governs access by the user space applications (i.e. by the agent and the set of other user space applications implemented by the processor 301) to software functions that can be implemented by the data processing system.

The agent can signal the kernel 350 to determine a set of calls by a user space application, which may be one of the set of user space applications implemented by the processor 301 of computing device 300. The processor may signal the kernel to determine the set of calls by a user space application using a kernel mode hook. The set of calls may be provided to processor 301 by the kernel. In such implementations, the kernel is monitored by the agent. In some cases, the processor 301 may determine the set of calls by walking the call stack and detecting one or more previously called functions.

Alternative methods of determining sets of calls by user space applications may also be used in the present approach. For example, one or more calls may be determined by another user space application implemented by processor 301 that can monitor the kernel and log kernel events to a log file. The application may also log application-defined events to a log file. The logged events can be consumed in real-time or stored so that the log files can later be analyzed.

Such applications may be known as trace providers. For example, in the Windows operating system, events may be detected using mechanisms such as Event Tracing for Windows (ETW). ETW provides a mechanism to trace and log events, such as calls to software functions governed by the kernel, that are raised by user space applications and kernel-space drivers. The ETW application programming interface (API) may provide a set of functions that are available to kernel-mode components and drivers. ETW providers can raise events and can publish them to the Windows Event Log or can write events to an ETW session 360, which can be written to a trace file 370 or delivered processor 301 in real time.

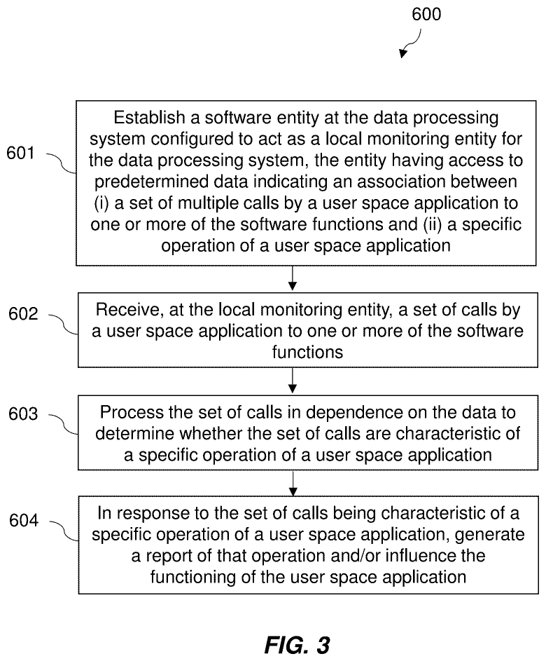

The system may first store the trace messages that trace providers generate in a trace session buffer and then deliver them directly to the agent (implemented by processor 301). The events can alternatively or additionally be written to a trace log. Such a log may be in the form of an event trace log file (.etl) as shown at 370 in FIG. 3. The processor 301 can receive the log file 370, which may specify a set of calls.

The processor 301 can analyze the received set of calls to determine whether the set of calls are characteristic of a specific operation of a user space application. The set of calls comprises one or more calls. In some examples, the set of calls comprises multiple calls.

The agent has access to data indicating an association between (i) a set of multiple calls by a user space application to one or more of the software functions and (ii) a specific operation of a user space application.

The agent can process the received set of calls (for example, received from the call stack or kernel, or from an event tracing application or log file) in dependence on the data to determine whether the set of calls are characteristic of a specific operation of a user space application of the user space applications implemented by the data processing system.

The specific operation of the user space application may be caused by a specific action (for example, a request) of a user of the user space application. The performance of the specific action may cause a security event to be raised by the processor. The specific action may be defined in one or more security policies, as described above. For example, the specific action of the user may be the user requesting to write a file to an external drive or email a restricted document to a personal account.

In some cases, the specific operation of the user space application may correspond to an application programming interface (API) call of the user space application. APIs provide users with convenient access to services at the computing device by implementing a user-friendly and compatible interface between the application and the operating system of the computing device. An API call allow an application to request data or services from another application. Typical operations that an API call can request include: extracting information from data held in a repository, modifying, copying or deleting data (such as files) stored in a depository, or initiating a prescribed data processing operation.

If the identified operation of the user space application corresponds to an action specified in a criterion, such as a security policy, a security event can then be raised corresponding to that or those user actions.

The processor 301 of the computing device 300 has access to the data indicating an association between a set of multiple calls by a user space application to one or more of the software functions and a specific operation of a user space application. The data may be stored at memory 302. Alternatively, the data may be stored at a remote location, for example at a cloud server, that is accessible to the processor 301. The data may be periodically updated. The data may be updated based on data collected at the computing device 300 or from other computing devices 200, 400 in the network 100, or other remote computing devices. The data may be received and/or updated from the central infrastructure apparatus 500. The data may be predetermined data.

The data may in some implementations specify patterns of calls, each pattern corresponds to a respective specific operation of a particular user space application (which may be one of one or more, or a plurality of, user space applications running on the data processing system). For example, where the data comprises patterns of calls and their corresponding operations of a user space application, the received set of calls can be compared with the patterns specified in the data to see if any of the patterns are identified in the received set of calls. The processor 301 can detect one or more patterns in the set of calls and compare the pattern(s) to patterns specified in the data If there is a match, this can indicate that the set of calls is the result of a specific operation of a particular user space application being performed at the data processing system. As mentioned above, a pattern of calls may be characteristic of a particular API call.

The data indicating an association between a set of multiple calls by a user space application to one or more of the software functions and a specific operation of a particular user space application may comprise a library of patterns. The library may comprise a plurality of patterns. Each pattern of the plurality of patterns may have a corresponding associated specific operation or operations of a user space application. Each pattern of the plurality of patterns may have a different associated specific operation.

In one example, the memory 302 of the device 300 may store a directed acyclic graph of patterns of calls. The processor 301 may traverse the graph to determine whether the received set of calls matches any of the patterns.

In some implementations, the specific operations and their associated patterns may be determined using API probes. For example, the patterns may be determined during previous operations of device 300 or another device by sending API probes to determine the operations being requested by users and recording the corresponding call patterns (for example by analyzing the calls in the stack or by monitoring the kernel) corresponding to the requested operation at the computing device. When those patterns of calls are then detected in the set of calls received by the processor (by signaling the kernel or otherwise), this can be used to infer the user operation(s) of a user space application that caused those software functions to be called.

The data indicating an association between a set of multiple calls by a user space application to one or more of the software functions and a specific operation of a user space application may comprise a model. The data may be defined by parameters of a model. The model may be received from the central infrastructure apparatus 500. The model may be stored at the memory 302 of the device 300 and be accessible by the processor 301. The processor 301 may execute the model. The model may take as input the set of calls received by the processor 301. The output of the model may be a specific operation of a user space application.

In some implementations, the data indicating an association between a set of multiple calls by a user space application to one or more of the software functions and a specific operation of a user space application may be learned. The model may be a machine learning model. The model may be trained to output one or more specific operations of user space application based on an input set of calls. The model may be trained using one or more data sets comprising multiple sets of calls and corresponding operations of user space applications.

One or more specific operations and respective associated sets of multiple calls may be learned based on user activity at the data processing system, or at another data processing system. The model may be trained based on data sets collected at another data processing system to the one implementing the model to infer the specific operation of a user space application based on the set of calls received at that data processing system (i.e. the data processing system at which the received set of calls to software functions are made). Data sets learned from activity at multiple data processing systems may be compiled and used to train a model. This may allow a model to be trained by the processor 301 or another remote processor). The model can then be implemented by processor 301 to detect patterns in the set of calls that are characteristic of specific operations of a user space application implemented by computing device 300.

In some implementations, the data may comprise one or more trained classifiers. The classifier may be an unsupervised, semi-supervised or supervised trained classifier (the latter two being trained with labelled datasets of specific operations and corresponding sets of calls). Once trained, the classifier may take the received set of calls as input and output a specific operation of a user space application based on the input set of calls. The classifier may be a multiclass classifier. The classifier can be trained to match call stacks resulting from specific operations of user space applications. The classifier may give a discrete output indicating a specific operation of a user space application.

The model may alternatively be a state machine, which is a behavioral model having a finite number of states. Such models may also be referred to as finite state machines (FSM). A state machine may be built in the kernel with pattern matchers to detect specific operations corresponding to a received set of calls.

In some cases, each call may have a corresponding memory address. The processor may process the set of calls by processing the memory addresses corresponding to each call. The memory addresses corresponding to set of calls may be characteristic of a specific user operation. The data may comprise patterns of memory addresses, each pattern of memory addresses corresponding to a specific user operation.

Some examples of calls corresponding to a specific operation are as follows.

In one example, a user may request to copy a file and a user space application may call a ‘Copy File’ API. In response the this, the system may open source and destination files and run a copy loop. The ‘Copy File’ API may make a set of calls to software functions in order to perform operations associated with copying the file, such as opening the source and destination files. This can leave a ‘footprint’ in the call stack at the kernel side that can be detected by the agent without a user space hook and matched with the copy file operation initiated at the user space application. Once the agent has determined that the call stack contains a set of calls that are characteristic of a copy file operation, the agent can generate a report (for example, raise an event) or block the copy operation or subsequent copy operations. This may allow operations involving the copying of a file to be detected without monitoring operations of user space applications in the user space.

In another example, a user may share a file during a video call. The data processing system can run a video conferencing application in user space. The video conferencing application can, in response to a user request to share a file, open the file and read from it. The set of calls corresponding to the open and read operations may come from a specific path within the application code, which can be detected in the call stack by the agent. In response to detecting the set of calls corresponding to the user operation in the call stack, the agent can generate a report (for example, raise an event) or block the file sharing operation and/or subsequent file sharing operations within the video conferencing application.

In another example, a user space application may open a network connection. The network connection may be a Secure Shell (SSH) client, for example using the File Transfer Protocol (FTP) or SFTP (SSH File Transfer Protocol). In doing this, the system may call some socket APIs and connect to remote destinations. By monitoring the kernel and determining a set of calls corresponding to the opening of the network connection, the agent can generate a report and/or determine whether to block the connection.

The above approaches may also be performed in conjunction with file exfiltration analysis techniques. For example, one or more user space applications may leave a trace of characteristic calls in the call stack when the application(s) open or copy a file and then makes a network connection. In the examples described herein, the agent may make a decision on whether to block a user operation involving a file in dependence on one or more particular attributes of a file, for example, file content or a part thereof, properties or characteristics of the file (such as file type, file name etc.), or metadata associated with the file. If the one or more file attributes indicate that the file is of relatively low importance, the agent may just generate a report rather than blocking the operation. However, if the one or more file attributes indicate that the file is of relatively high importance, the agent may influence the functioning of the user space application by blocking the operation involving the file.

In the previously described example, where one or more applications open or copy a file and then make a network connection, the agent may determine whether to report and/or block the operation in dependence on one or more attributes of the file. This may help to prevent sensitive files from being copied and exfiltrated via a network connection.

In some cases, the received set of calls may comprise calls from multiple operations of a user space application or operations of more than one user space application. The processor 301 may analyze the set of calls with respect to the data to determine which calls of the set of calls are characteristic of the specific operation of the user space application. For example, the processor 301 may analyze the set of calls to determine whether the sets of calls comprises one or more patterns of calls that are indicative of one or more specific operations of a user space application.

The system may trigger actions when it detects a request from a user space API, for example a request from a specific application to access a certain kernel function. In one instance, the system may trigger an action when a predetermined library calls a predetermined kernel function. The action may be to block the request, to log the request or to generate a risk score associated with the request that can be used to supplement heuristic monitoring of the system. To illustrate this mode of operation, when a Windows user copies a file to a USB drive, the file explorer may call the CopyFile( ) function in kernelbase.dll. The system may trigger an action when this API call is detected without impacting other file operations.

In some implementations there may be a filter that posts pre-operation callbacks. This is known as a minifilter in typical Windows environments. In such an implementation, the system described herein could be called in a different thread from the filter, for example in the thread of a kernel system worker. To accommodate this, the system described herein could inspect the thread that issued a certain I/O request. In a typical Windows environment this may be done using commands such as PsGetContextThread( ), RtlLookupFunctionEntry( ) or RtlVirtualUnwind( ).

In some circumstances, calls may be made using dynamic hooks. This can result in a series of calls having a hook interposed. There can then be two possible sequences of calls that are functionally similar. To detect calls that may contain hooks, a heuristic or fuzzy matching process can be used. The basis for the matching process may, for example, be a Jaccard distance or may be estimated using dynamic time warping. By tracking module offsets rather than absolute addresses, the system can detect given operations despite any address space randomization that may be in use. In each case, the heuristic matching may involve allocating a score to an event, the mapping of scores to events having been predetermined. These can be added up. If the score for a given process, optionally over a given time, exceeds a predetermined threshold then an action can be taken: for example blocking or logging that process.

In some implementations, each time a user space application updates to a different version, the application binary may be updated. When the agent records a call stack trace when a user attempts to upload a file when running a particular version of an application, that pattern may only be valid for that version of the application. In some examples, the call stack might look different for different versions of an application. The agent may keep a database of application versions and their corresponding patterns of calls. This knowledge may be shared with agents running at other data processing systems, for example via the central infrastructure apparatus.

Once a pattern of calls has been recorded for one version of an application, this may be stored for use as a baseline. When other versions of the application are subsequently used, the structure of the function in terms of control flow may look similar to the baseline pattern when using some metrics. For example, they may have similar control flow graphs. Heuristic matching may be used to determine the similarity between the call sites, e.g. the similarity between the functions' control flow graphs or the ratio of assembly language instructions around the call site. This may, for example, be the ratio of one or more of mov, jmp and call to one or more other of those instructions. PDB (program database) files may also be used to determine the functioning containing the call site by mapping the containing function back to a human readable name.

For a version of an application with an unknown binary, the call stack traces may look similar to the baseline, and the agent may consider a detected set of calls to correspond to a specific operation of a user space application if the detected set of calls and the known pattern (e.g. the baseline) corresponding to that specific operation are similar. For example, the detected set of calls and one of the patterns may differ by less than a predetermined number of calls. After the agent has matched the set of calls to a specific operation of a user space application, the agent may store the newly detected (different) pattern of calls so that it can be matched to future detections. This may allow the agent to detect specific operations of user space applications for different versions of an application and may help the agent to automatically learn the correct matching pattern for an unknown binary version of an application.

In some implementations, the caller of a user space API may use wrapper functions which take different code paths depending on the API parameters. For example, a destination file to be saved at an external storage device, such as a USB drive, may take a different code path to the same file shared via a network, or some operation flags. This may also be true of the user space API implementation itself. For example, CopyFile( ) may call BaseCopyStream( ) internally, which may use different code to copy the file depending on the file properties and/or operation flags. This can result in different patterns of calls to software functions at the kernel depending on the file properties and/or the file being copied. To determine such patterns that can be stored as data indicating an association between (i) a set of multiple calls by a user space application to one or more of the software functions and (ii) a specific operation of a user space application (e.g. an operation to copy a file) that can be used to determine whether received sets of calls are characteristic of a specific operation of a user space application, multiple probes can be sent to determine the set of code paths and associated matchers (set of calls). The code paths can also be factorized to produce a single matcher, which may be masked to handle the full set of associated calls.

The data indicating an association between (i) a set of multiple calls by a user space application to one or more of the software functions and (ii) a specific operation of a user space application may be acquired by the data processing system, or one or more other data processing systems. This may be achieved by monitoring the data processing system for a short period of time to watch user actions, for example using keyboard and/or mouse hooks, which may also recognize shortcuts used by keyboard commends (e.g. Cntrl C to copy). At the same time, stack patterns in the kernel can be monitored to learn the association between sets of calls by a user space application to one or more software functions and specific operations of a user space application. The use of user space hooks may be relatively expensive, and so it is desirable to do this for only a short period of time. Once the data indicating an association between sets of multiple calls by a user space application to one or more of the software functions and specific operations of a user space application has been established, the agent may then only monitor sets of calls in the kernel space (and not the user space) and match any detected sets of calls known to correspond to specific operations of user space applications. In other words, data indicating an association between (i) a set of multiple calls by a user space application to one or more of the software functions and (ii) a specific operation of a user space application may be determined by monitoring operations of the user space application and corresponding calls to one or more of the software functions. Once patterns of calls have been detected at a particular data processing system, these can also be shared with the central infrastructure apparatus and/or with agents operating at other data processing systems.

In response to the determined set of calls being characteristic of a specific operation of a user space application, the computing device 300 may generate a report of that operation. The report may be in the form of a security event discussed above that can be sent to a remote monitoring entity such as the central infrastructure apparatus 500. The user whose actions caused the event to be raised can optionally be flagged for future monitoring. The raising of the event may result in certain user operations being blocked, which may improve the security of devices in a network.

In response to the determined set of calls being characteristic of a specific operation of a user space application, the data processing system can alternatively or additionally influence the functioning of the user space application. For example, the user space application may be terminated, or the functioning of the user space application may be modified by modifying future calls by the user space application to one or more software functions. In one example, the agent may redirect the execution of the called functions via call stack manipulation.

By determining the set of calls made to one or more of the software functions to which the kernel governs access, the specific operation of the application may conveniently be inferred without a user space hook. This may allow events to be raised by the agent if the specific operation(s) is/are one(s) which are defined in a security policy, or other criteria. The events can then be reported to the central infrastructure apparatus 500 as described above.

FIG. 3 shows the steps of an exemplary method for implementation at a data processing system. The data processing system is configured to implement one or more user space applications and an operating system kernel. The operating system kernel governs access by the user space applications to software functions that can be implemented by the data processing system.

At step 601, the method comprises establishing a software entity at the data processing system configured to act as a local monitoring entity for the data processing system, the entity having access to data indicating an association between (i) a set of multiple calls by a user space application to one or more of the software functions and (ii) a specific operation of a user space application. At step 602, the method comprises receiving, at the local monitoring entity, a set of calls by a user space application to one or more of the software functions. At step 603, the method comprises processing the determined set of calls in dependence on the data to determine whether the calls are characteristic of a specific operation of a user space application. At step 604, in response to the determined set of calls being characteristic of a specific operation of a user space application, the method comprises generating a report of that operation and/or influence the functioning of the user space application.

The approach described herein can be used to determine a user space application's intent within a kernel mode callback. The approach can allow operations of a user space application to be determined without requiring a user space hook. As the call stack is generally stored in a data cache, rather than in the memory of the device, operations to match the set of calls to a specific operation of a user space application can be performed quickly, easily and cheaply and may require very few instructions. The process can thus be much quicker and less memory-consuming than processing involving a cache miss or memory access. The process may result in speed increases that are approximately two orders of magnitude faster than existing methods. The approach also does not impact the user experience.

Probing and recording execution traces to detect patterns of calls corresponding to specific user operations to be detected later at the call stack may also be more resilient to call path modifications by other hooks.

The method is compatible with both non-warped and time-warped algorithms. Non-warped algorithms can be performed with simple vector operations between patterns and stack module IDs/offset tuples which can be very fast, resulting in a significantly lower increase in work in the callback and reduced latency impact on the operation. Fast algorithms and other implementations also exist for time warping.

The apparatus described herein may prevent malicious activities from occurring by allowing specific operations of a user space application to be detected, so that events can be raised in a computationally efficient matter. This can be used to alert on suspicious behaviour. In response, the computing devices may block activities such as the uploading of confidential files to personal drives.

The apparatus may improve cyber hygiene and keep data and endpoints secure, regardless of location (for example, whether the user is in the office or working remotely) and network connection (for example public WiFi or VPN). This may help to protect data from leaks and breaches, may help to ensure that users are not downloading potentially unsanctioned applications without going through the correct channels, and may assist in blocking data shared via prohibited cloud storage applications, personal email addresses, and personal storage devices such as USB sticks.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the disclosure.

What is claimed is:

1. A non-transitory machine readable medium storing instructions, which when executed by one or more processors of a data processing system, cause the one or more processors to:
establish a software entity at the data processing system configured to act as a local monitoring entity for the data processing system, the entity having access to data indicating, for each user space application of a plurality of user space applications, an association between (i) a set of multiple calls by the user space application to one or more software functions and (ii) a specific operation of the user space application;
receive, at the local monitoring entity, a set of calls by a given user space application of the plurality of user space applications to one or more software functions;
determine the set of calls are characteristic of a specific operation of the given user space application by processing the set of calls based on the data; and
perform one or both of generating a report regarding the specific operation and influencing functioning of the given user space application.

2. The non-transitory machine readable medium of claim 1, wherein at least one of the set of calls are determined by, using the local monitoring entity, signaling an operating system (OS) kernel of the data processing system to determine one or more calls by the given user space application to one or more of the software functions.

3. The non-transitory machine readable medium of claim 2, wherein the instructions further cause the one or more processors to signal the OS kernel to determine the set of calls by the given user space application using a kernel mode hook.

4. The non-transitory machine readable medium of claim 1, wherein at least one of the set of calls is determined using an event tracing application.

5. The non-transitory machine readable medium of claim 4, wherein the instructions further cause the one or more processors to receive an event trace log file from the event tracing application and determine the set of calls from the event trace log file.

6. The non-transitory machine readable medium of claim 1, wherein the specific operation of the given user space application comprises an application programming interface call of the given user space application.

7. The non-transitory machine readable medium of claim 1, wherein said processing the set of calls based on the data comprises processing memory addresses specified by the set of calls.

8. The non-transitory machine readable medium of claim 1, wherein the instructions further cause the one or more processors to learn one or more specific operations and respective associated sets of multiple calls based on user activity at the data processing system.

9. The non-transitory machine readable medium of claim 1, wherein the data comprises predetermined data.

10. The non-transitory machine readable medium of claim 1, wherein the data comprises a trained machine learning model and wherein the trained machine learning model is implemented by the one or more processors to process the set of calls to determine whether the set of calls are characteristic of the specific operation of the given user space application.

11. The non-transitory machine readable medium of claim 10, wherein the trained machine learning model is trained based on activity at one or more other data processing devices.

12. The non-transitory machine readable medium of claim 1, wherein the data comprises one or more trained classifiers.

13. The non-transitory machine readable medium of claim 1, wherein the instructions further cause the one or more processors to detect one or more patterns in the set of calls and compare the one or more pattern to patterns specified in the data.

14. The non-transitory machine readable medium of claim 13, wherein the data comprises a library of patterns of calls, each pattern having a corresponding associated specific operation of a particular user space application of the plurality of user space applications.

15. The non-transitory machine readable medium of claim 13, wherein a given specific operation and an associated patterns of calls are determined using application programming interface probes.

16. The non-transitory machine readable medium of claims 13, wherein the instructions further cause the one or more processors to based on the received set of calls differing from one of the patterns specified in the data by less than a threshold number of calls, determine the received set of calls as being characteristic of the corresponding associated specific operation of the particular user space application corresponding to that one pattern of the patterns and perform one or both of generating a report of the corresponding associated specific operation and influencing functioning of the particular user space application.

17. The non-transitory machine readable medium of claim 16, wherein the instructions further cause the one or more processors to store the received set of calls as a new pattern in the data indicating an association between (i) the received set of calls and (ii) the specific operation of the particular user space application corresponding to that one pattern.

18. The non-transitory machine readable medium of claim 17, wherein the new pattern corresponds to a version of the particular user space application unknown to the software entity.

19. The non-transitory machine readable medium of claim 1, wherein the determined set of calls comprises calls from multiple operations of the given user space application or operations of more than one user space application, and wherein the instructions further cause the one or more processors to determine which calls of the set of calls are characteristic of the specific operation of the given user space application.

20. The non-transitory machine readable medium of claim 1, wherein said influencing functioning of the given user space application comprises modifying future calls by the given user space application to the one or more software functions.

21. The non-transitory machine readable medium of claim 1, wherein the instructions further cause the one or more processors to terminate the given user space application.

22. The non-transitory machine readable medium of claim 1, wherein the specific operation of the user space application comprises one or more of opening a file, copying a file, exfiltrating a file and opening a network connection.

23. A method comprising:
establishing a software entity at a data processing system configured to act as a local monitoring entity for the data processing system, the entity having access to data indicating, for each user space application of a plurality of user space applications, an association between (i) a set of multiple calls by the user space application to one or more software functions and (ii) a specific operation of the user space application;
receiving, at the local monitoring entity, a set of calls by a given user space application of the plurality of user space applications to one or more software functions;
determining the set of calls are characteristic of a specific operation of the given user space application by processing the set of calls based on the data; and
performing one or both of generating a report regarding the specific operation and influencing functioning of the given user space application.

24. A data processing system comprising:
one or more processors; and
instructions that when executed by the one or more processors cause the one or more processors to:
establish a software entity at the data processing system configured to act as a local monitoring entity for the data processing system, the entity having access to data indicating, for each user space application of a plurality of user space applications, an association between (i) a set of multiple calls by the user space application to one or more software functions and (ii) a specific operation of the user space application;
receive, at the local monitoring entity, a set of calls by a given user space application of the plurality of user space applications to one or more software functions;
determine the set of calls are characteristic of a specific operation of the given user space application by processing the set of calls based on the data; and
perform one or both of generating a report regarding the specific operation and influencing functioning of the given user space application.
